(19) United States
(12) Patent Application Publication
(10) Pub. No.: US 2025/0117229 A1
(43) Pub. Date: Apr. 10, 2025

(54) ELECTRONIC DEVICE AND METHOD OF HANDLING A SELF-ADAPTIVE MECHANISM

(71) Applicant: MEDIATEK INC., Hsinchu City (TW)

(72) Inventors: Yi-Wei Ho, Hsinchu City (TW); Hsien-Hsi Hsieh, Hsinchu City (TW); Kan-Yao Chang, Hsinchu City (TW); Wei-Shuo Chen, Hsinchu City (TW); Chung-Yang Chen, Hsinchu City (TW); Cheng-Che Chen, Hsinchu City (TW)

(73) Assignee: MEDIATEK INC., Hsinchu City (TW)

(21) Appl. No.: 18/906,139

(22) Filed: Oct. 3, 2024

Related U.S. Application Data
(60) Provisional application No. 63/588,306, filed on Oct. 6, 2023.

(51) Int. Cl. G06F 9/445; A63F 13/77

(52) U.S. Cl. CPC G06F 9/4451; A63F 13/77

(57) ABSTRACT

An electronic device includes a processor arranged to execute an application, a platform and a middleware. The application is configured to execute operations of: providing at least one acceptable quality and at least one priority of the at least one profile parameter. The platform is configured to execute an operation of: providing platform information in response to a demand request. The middleware is configured to execute operations of: receiving the at least one acceptable quality and the at least one priority from the application; receiving the platform information from the platform; performing a self-adaptive algorithm according to the platform information to generate a result; adjusting the at least one profile parameter according to the result, the at least one acceptable quality and the at least one priority; and transmitting an adjustment notification to the platform, after adjusting the at least one profile parameter.

### CROSS REFERENCE TO RELATED APPLICATIONS

This application claims the benefit of U.S. Provisional Application No. 63/588,306, filed on Oct. 6, 2023. The content of the application is incorporated herein by reference.

### BACKGROUND

Gaming is an important user scenario of electronic devices. Performances tunning to improve the user experiences and keep a maximum average frame rate for a longer time are the keys of a product selling point. However, the application and the platform of an electronic device do not communicate with each other for the resource demands and a platform system status, which resulting in worse performances. Without a platform hint, the application cannot adjust profiles and/or resource demands to accommodate system resource limitation. Without an application hint, a platform cannot response the resource demands in time when the application requires, and needs to speed up hardware frequency for a specific period to ensure a heavy loading task can be finished before the task been issued. In addition, game vendors need to design adaptive algorithms in games to connect the electronic devices with the games.

### SUMMARY

It is an objective of the invention to provide an electronic device and a method, in order to solve the above problem.

An embodiment of the invention provides an electronic device comprising a processor. The processor is arranged to execute an application, a platform and a middleware. The application is configured to execute operations of: providing at least one acceptable quality of at least one profile parameter; and providing at least one priority of the at least one profile parameter. The platform is configured to execute an operation of: providing platform information in response to a demand request. The middleware is configured to execute operations of: receiving the at least one acceptable quality from the application; receiving the at least one priority from the application; receiving the platform information from the platform; performing a self-adaptive algorithm according to the platform information to generate a result; adjusting the at least one profile parameter according to the result, the at least one acceptable quality and the at least one priority; and transmitting an adjustment notification to the platform, after adjusting the at least one profile parameter.

An embodiment of the invention provides a method for handling a self-adaptive mechanism of an electronic device comprising an application, a platform and a middleware: providing, by the application, at least one acceptable quality of at least one profile parameter; providing, by the application, at least one priority of the at least one profile parameter; providing, by the platform, platform information in response to a demand request; receiving, by the middleware, the at least one acceptable quality from the application; receiving, by the middleware, the at least one priority from the application; receiving, by the middleware, the platform information from the platform; performing, by the middleware, a self-adaptive algorithm according to the platform information to generate a result; adjusting, by the middleware, the at least one profile parameter according to the result, the at least one acceptable quality and the at least one priority; and transmitting, by the middleware, an adjustment notification to the platform, after adjusting the at least one profile parameter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of an electronic device according to an embodiment of the invention.

FIG. 2 is a flowchart of a process according to an embodiment of the invention.

FIG. 3 is a flowchart of a process according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

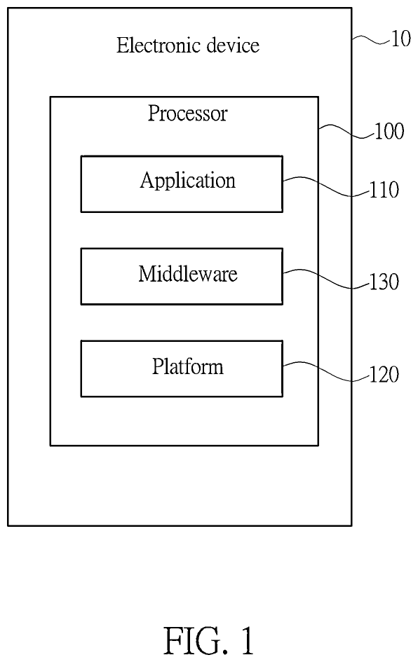

FIG. 1 is an exemplary block diagram of an electronic device 10 according to an embodiment of the invention. The electronic device 10 is utilized to handle a self-adaptive mechanism, and comprises a processor 100. The processor 100 is arranged to execute an application 110, a platform 120 and a middleware 130. The application 110 is configured to provide at least one acceptable quality of at least one profile parameter, and provide at least one priority of the at least one profile parameter. The platform 120 is configured to provide platform information (or called a platform system hint) in response to a demand request. The middleware 130 is configured to receive the at least one acceptable quality from the application, receive the at least one priority from the application, receive the platform information from the platform, perform a self-adaptive algorithm according to the platform information to generate a result, adjust the at least one profile parameter according to the result, the at least one acceptable quality and the at least one priority, and transmit an adjustment notification to the platform after adjusting the at least one profile parameter.

In an embodiment of the invention, the electronic device 10 is a user equipment (UE), a mobile phone, a laptop, a tablet computer, a smart watch or a portable computer system, but is not limited herein. In an embodiment of the invention, the middleware 130 is an application level library or a game engine, but is not limited herein. In an embodiment of the invention, the game engine is a unity or unreal engine. In an embodiment of the invention, the middleware 130 comprises an overall possible call-flow between the application 110 and the platform 120. In an embodiment of the invention, the at least one acceptable quality comprises (e.g., is) at least one minimally acceptable quality or at least one maximally acceptable quality. In an embodiment of the invention, the at least one priority comprises (e.g., is) at least one priority for a loading degradation and/or at least one priority for a loading escalation. In an embodiment of the invention, the at least one profile parameter comprises (e.g., is) a graphic detail, but is not limited herein.

In an embodiment of the invention, the at least one profile parameter comprises at least one of a frame rate, a physics simulation update rate, an animation simulation update rate, a post-processing effects switch, a level of detail (LOD), a LOD switch distance (e.g., a texture's LOD switch distance or a mesh's LOD switch distance), a resolution, a camera view distance, an anti-aliasing algorithms sample count, a shadow view distance and a particle simulation update rate, but is not limited herein. In an embodiment of the invention, the platform information comprises at least one system index (e.g., at least one profile change system index) associated with at least one performance of the electronic device. In an embodiment of the invention, the at least one performance comprises at least one of a frame rate, a hardware (e.g., central processing unit (CPU)) loading, a skin (or cover) temperature, a thermal condition, a power consumption and a battery consumption, but is not limited herein.

In an embodiment of the invention, the middleware 130 transmits the demand request to the platform 120, e.g., if the at least one profile parameter is needed to adjust. In an embodiment of the invention, the demand request is an upper layer resource demand request or a profile list performance demand request, but is not limited herein. In an embodiment of the invention, the operation of the middleware 130 to perform the self-adaptive algorithm according to the platform information comprises: calculating at least one average value associated with the at least one performance according to the platform information; and determining whether the at least one average value satisfies at least one condition, respectively, to generate the result.

In an embodiment of the invention, the at least one average value comprises at least one of an average frame rate, an average skin (or cover) temperature and an average power, but is not limited herein. In an embodiment of the invention, the at least one condition comprises at least one of the following conditions: (1) the average frame rate is smaller than a difference of a target frame rate and a tolerance; (2) the average skin (or cover) temperature is greater than a target skin (or cover) temperature; (3) the average skin (or cover) temperature is greater than a product of a first weight (e.g., 0.9) and the target skin (or cover) temperature, and the average skin (or cover) temperature is greater than a last skin (or cover) temperature; (4) the average power is greater than a target power; and (5) the average power is smaller than a product of a second weight (e.g., 0.9) and the target power. In an embodiment of the invention, the target frame rate, the target skin (or cover) temperature, the target power and the last skin (or cover) temperature are comprised in the platform information. In an embodiment of the invention, the tolerance, the first weight and the second weight are determined by the platform 120 and/or the middleware 130 according to a current scenario. In an embodiment of the invention, the result indicates a loading degradation or a loading escalation.

In an embodiment of the invention, the middleware 130 adjusts the at least one profile parameter according to the current scenario. A Table 1 is an embodiment of profile parameters adjusted according to different scenarios as follows. In the Table 1, the profile parameters comprise a frame rate, a physics simulation update rate, an animation simulation update rate, a post-processing effects switch, a LOD switch distance, a resolution, a camera view distance, an anti-aliasing algorithms sample count, a shadow view distance and a particle simulation update rate. If a (current) CPU loading is heavier than a (current) graphics processing unit (GPU) loading, the middleware 130 may adjust the frame rate, the physics simulation update rate, the animation simulation update rate, the camera view distance, the shadow view distance and/or a particle simulation update rate. If the (current) GPU loading is heavier than the (current) CPU loading, the middleware 130 may adjust the post-processing effects switch, the LOD switch distance, the resolution, the camera view distance, the anti-aliasing algorithms sample count, the shadow view distance and/or the particle simulation update rate. The middleware 130 selects one or more profile parameters to adjust according to priorities of the profile parameters.

TABLE 1

| | CPU loading > GPU | GPU loading > CPU |
|---|---|---|
| Profile parameter | loading | loading |
| Frame rate | V | |
| Physics simulation | V | |
| update rate | | |
| Animation simulation | V | |
| update rate | | |
| Post- processing | | V |
| effects switch | | |
| LOD switch distance | | V |
| Resolution | | V |
| Camera view distance | V | V |
| Anti-aliasing | | V |
| algorithms sample count | | |
| Shadow view distance | V | V |
| Particle simulation | V | V |
| update rate | | |

In an embodiment of the invention, the adjustment notification is a platform resource boost hint, but is not limited herein. The adjustment notification is utilized to improve performances for an incoming heavy task. In an embodiment of the invention, the application 110 further provides adjustable levels of the at least one profile parameter, and the middleware 130 further receives the adjustable levels from the application. In an embodiment of the invention, the middleware 130 adjusts the at least one profile parameter according to the adjustable levels, the result, the at least one acceptable quality and the at least one priority.

A Table 2 is an embodiment of profile parameters as follows. The middleware 130 may receive (or obtain) the Table 2 from the application 110, and the Table 2 provides adjustable levels, priorities for a loading degradation and minimum acceptable qualities of the profile parameters. Therefore, the middleware 130 may adjust the profile parameters according to the Table 2. In the Table 2, the profile parameters comprise a frame rate, a physics simulation update rate, an animation simulation update rate, a post-processing effects switch, a LOD switch distance, a resolution, a camera view distance, an anti-aliasing algorithms sample count, a shadow view distance and a particle simulation update rate. The middleware 130 may adjust the physics simulation update rate to 30, 60, 90 or 120 frames per second (fps), may adjust the resolution to 720, 960 or 1080 pixel (p) and/or may adjust the shadow view distance to 500, 600, 700 or 800 meters (m). The middleware 130 may adjust the frame rate to 60, 90 or 120 fps, since the minimum acceptable quality of the frame rate is 60 fps. The middleware 130 may adjust the animation simulation update rate, the post-processing effects switch, the LOD switch distance, the camera view distance, the anti-aliasing algorithms sample count and/or the particle simulation update rate according to the Table 2, and is not narrated herein for brevity.

TABLE 2

| | | Priority for | Minimum | |
|---|---|---|---|---|
| Profile | Adjustable | loading | acceptable | |
| parameter | level | degradation | quality | |
| Frame rate | 30, 60, 90 and 120 fps | 5 | 60 | fps |
| Physics | 30, 60, 90 and 120 fps | 2 | 30 | fps |
| simulation | | | | |
| update rate | | | | |
| Animation | 30, 60, 90 and 120 fps | 2 | 60 | fps |
| simulation | | | | |
| update rate | | | | |
| Post- | on and off | 4 | off | |
| processing | | | | |
| effects switch | | | | |
| LOD switch | 500, 600, 700 and 800 m | 3 | 600 | m |
| distance | | | | |
| Resolution | 720, 960 and 1080 p | 4 | 720 | p |
| Camera view | 500, 600, 700 and 800 m | 3 | 500 | m |
| distance | | | | |
| Anti-aliasing | 1x, 2x, 4x and 8x | 1 | 2x | |
| algorithms | | | | |
| sample count | | | | |
| Shadow view | 500, 600, 700 and 800 m | 1 | 500 | m |
| distance | | | | |
| Particle | 30, 60, 90 and 120 fps | 1 | 60 | fps |

simulation
update rate

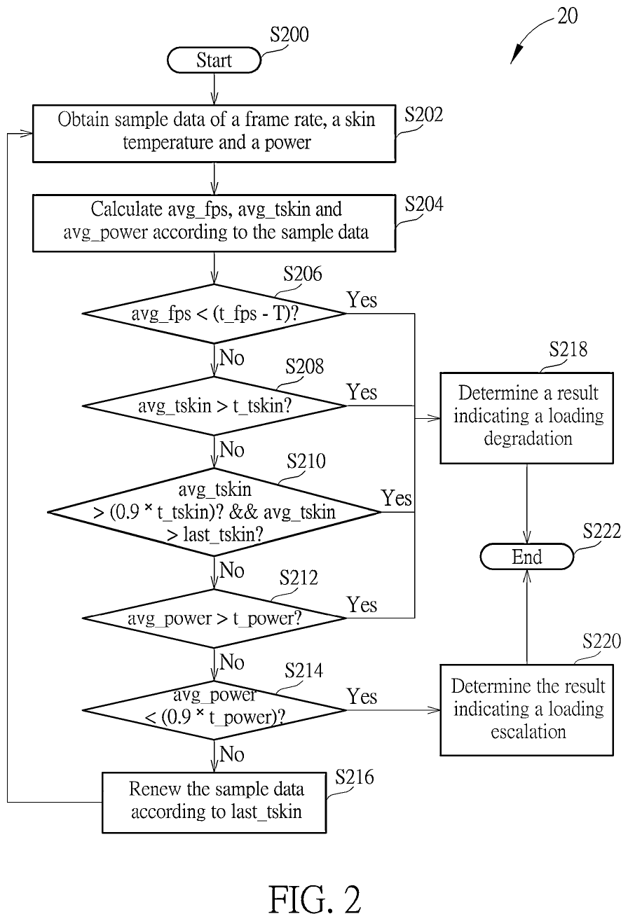

FIG. 2 is a flowchart of a process 20 according to an embodiment of the invention. The process 20 is utilized in the middleware 130 to perform the self-adaptive algorithm. Provided that the result is substantially the same, the steps are not required to be executed in the exact order shown in FIG. 2. The process 20 comprises the following steps:
Step S200: Start.
Step S202: Obtain sample data of a frame rate, a skin temperature and a power.
Step S204: Calculate an average frame rate avg_fps, an average skin temperature avg_tskin and an average power avg_power according to the sample data.
Step S206: Is the average frame rate avg_fps smaller than a difference of a target frame rate t_fps and a tolerance T? If yes, perform Step S218. If no, perform Step S208.
Step S208: Is the average skin temperature avg_tskin greater than a target skin temperature t_tskin? If yes, perform Step S218. If no, perform Step S210.
Step S210: Is the average skin temperature avg_tskin greater than a product of 0.9 and the target skin temperature t_tskin, and is the average skin temperature avg_tskin greater than a last skin temperature last_tskin? If both yes, perform Step S218. Otherwise, perform Step S212.
Step S212: Is the average power avg_power greater than a target power t_power? If yes, perform Step S218. If no, perform Step S214.
Step S214: Is the average power avg_power smaller than a product of 0.9 and the target power t_power? If yes, perform Step S220. If no, perform Step S216.
Step S216: Renew the sample data according to the last skin temperature last_tskin, and perform Step S202.
Step S218: Determine a result indicating a loading degradation, and perform Step S222.
Step S220: Determine the result indicating a loading escalation.
Step S222: End.

In an embodiment of the invention, the middleware 130 obtains the sample data by receiving the platform information from the platform 120. In an embodiment of the invention, the middleware 130 obtains the sample data by monitoring the electronic device 10. For example, a monitor period is 10 seconds (sec), i.e., a data sample rate is 0.1 time/sec. In an embodiment of the invention, the middleware 130 obtains the sample data by performing Step S216. In an embodiment of the invention, at least one of Steps S206-S214 is not performed (i.e., can be ignored) according to the current scenario.

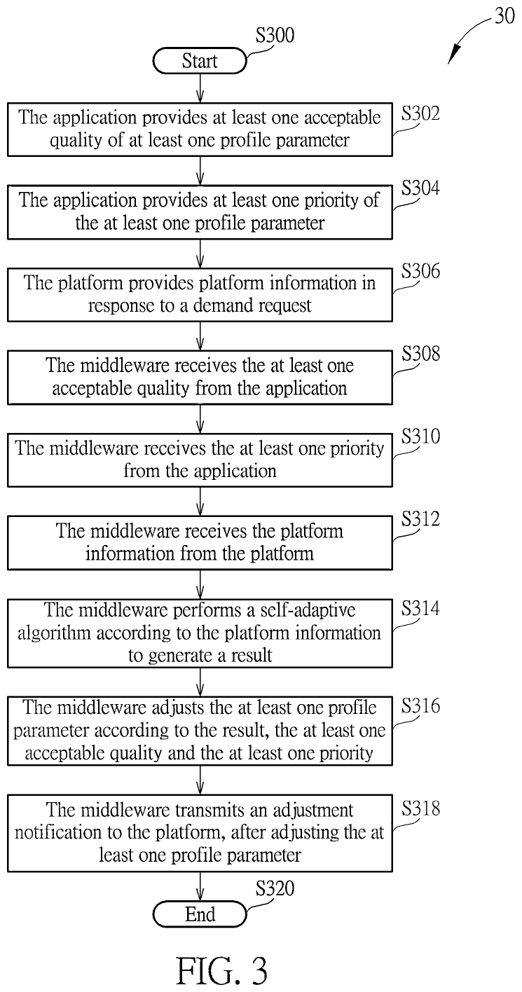

Operations of the electronic device 10 comprising the application 110, the platform 120 and the middleware 130 in the above examples can be summarized into a process 30 shown in FIG. 3, to handle a self-adaptive mechanism. The process 30 includes the following steps:
Step S300: Start.
Step S302: The application 110 provides at least one acceptable quality of at least one profile parameter.
Step S304: The application 110 provides at least one priority of the at least one profile parameter.
Step S306: The platform 120 provides platform information in response to a demand request.
Step S308: The middleware 130 receives the at least one acceptable quality from the application 110.
Step S310: The middleware 130 receives the at least one priority from the application 110.
Step S312: The middleware 130 receives the platform information from the platform 120.
Step S314: The middleware 130 performs a self-adaptive algorithm according to the platform information to generate a result.
Step S316: The middleware 130 adjusts the at least one profile parameter according to the result, the at least one acceptable quality and the at least one priority.
Step S318: The middleware 130 transmits an adjustment notification to the platform 120, after adjusting the at least one profile parameter.
Step S320: End.

The process 30 is used for illustrating the operations of the electronic device 10. Detailed description and variations of the process 30 can be referred to the previous description, and are not narrated herein for brevity.

The operation of “determine” described above may be replaced by the operation of “compute”, “calculate”, “obtain”, “generate”, “output”, “use”, “choose/select”, “decide” or “is configured to”. The phrase of “according to” described above may be replaced by “in response to” or “by using”. The term of “via” described above may be replaced by “on”, “in” or “at”. The term of “associated with” may be replaced by “of” or “related to”.

To sum up, the present invention provides an electronic device and a method for handling a self-adaptive mechanism. The SCO platform and the middleware communicate directly with each other (e.g., by the platform information and the adjustment notification) to achieve better user experiences. The self-adaptive algorithm is performed by the middleware, and thus the game vendors are able to avoid designing adaptive algorithms in the games.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a processor, arranged to execute:
an application, configured to execute operations of:
providing at least one acceptable quality of at least one profile parameter; and
providing at least one priority of the at least one profile parameter;
a platform, configured to execute an operation of:
providing platform information in response to a demand request; and
a middleware, configured to execute operations of:
receiving the at least one acceptable quality from the application;
receiving the at least one priority from the application;
receiving the platform information from the platform;
performing a self-adaptive algorithm according to the platform information to generate a result;
adjusting the at least one profile parameter according to the result, the at least one acceptable quality and the at least one priority; and
transmitting an adjustment notification to the platform, after adjusting the at least one profile parameter.

2. The electronic device of claim 1, wherein the at least one profile parameter comprises at least one of a frame rate, a physics simulation update rate, an animation simulation update rate, a post-processing effects switch, a level of detail (LOD), a LOD switch distance, a resolution, a camera view distance, an anti-aliasing algorithms sample count, a shadow view distance and a particle simulation update rate.

3. The electronic device of claim 1, wherein the platform information comprises at least one system index associated with at least one performance of the electronic device.

4. The electronic device of claim 3, wherein the at least one performance comprises at least one of a frame rate, a hardware loading, a skin temperature, a thermal condition, a power consumption and a battery consumption.

5. The electronic device of claim 1, wherein the middleware transmits the demand request to the platform.

6. The electronic device of claim 1, wherein the operation of performing the self-adaptive algorithm according to the platform information comprises:
calculating at least one average value associated with the at least one performance according to the platform information; and
determining whether the at least one average value satisfies at least one condition, respectively, to generate the result.

7. The electronic device of claim 1, wherein the application further provides adjustable levels of the at least one profile parameter, and the middleware further receives the adjustable levels from the application.

8. The electronic device of claim 7, wherein the middleware adjusts the at least one profile parameter according to the adjustable levels, the result, the at least one acceptable quality and the at least one priority.

9. The electronic device of claim 1, wherein the middleware is an application level library or a game engine.

10. An method for handling a self-adaptive mechanism of an electronic device comprising an application, a platform and a middleware, comprising:
providing, by the application, at least one acceptable quality of at least one profile parameter;
providing, by the application, at least one priority of the at least one profile parameter;
providing, by the platform, platform information in response to a demand request;
receiving, by the middleware, the at least one acceptable quality from the application;
receiving, by the middleware, the at least one priority from the application;
receiving, by the middleware, the platform information from the platform;
performing, by the middleware, a self-adaptive algorithm according to the platform information to generate a result;
adjusting, by the middleware, the at least one profile parameter according to the result, the at least one acceptable quality and the at least one priority; and
transmitting, by the middleware, an adjustment notification to the platform, after adjusting the at least one profile parameter.

11. The method of claim 10, wherein the at least one profile parameter comprises at least one of a frame rate, a physics simulation update rate, an animation simulation update rate, a post-processing effects switch, a level of detail (LOD), a LOD switch distance, a resolution, a camera view distance, an anti-aliasing algorithms sample count, a shadow view distance and a particle simulation update rate.

12. The method of claim 10, wherein the platform information comprises at least one system index associated with at least one performance of the electronic device.

13. The method of claim 12, wherein the at least one performance comprises at least one of a frame rate, a hardware loading, a skin temperature, a thermal condition, a power consumption and a battery consumption.

14. The method of claim 10, wherein the middleware transmits the demand request to the platform.

15. The method of claim 10, wherein the operation of performing the self-adaptive algorithm according to the platform information comprises:
calculating, by the middleware, at least one average value associated with the at least one performance according to the platform information; and
determining, by the middleware, whether the at least one average value satisfies at least one condition, respectively, to generate the result.

16. The method of claim 10, further comprising:
providing, by the application, adjustable levels of the at least one profile parameter, and
receiving, by the middleware, the adjustable levels from the application.

17. The method of claim 16, the at least one profile parameter is adjusted according to the adjustable levels, the result, the at least one acceptable quality and the at least one priority.

18. The method of claim 10, wherein the middleware is an application level library or a game engine.
